(19) United States
(12) Patent Application Publication
(10) Pub. No.: US 2011/0066720 A1
(43) Pub. Date: Mar. 17, 2011

(54) NETWORK CONNECTION STATUS DETECTING SYSTEM AND METHOD THEREOF

(75) Inventors: JIAN-FEI WANG, Shanghai (CN); CHIH-LIANG WU, TAIPEI COUNTY (TW); SHANG-PIN LIN, TAIPEI COUNTY (TW)

(73) Assignees: INVENTEC APPLIANCES (SHANGHAI) CO. LTD., Shanghai (CN); INVENTEC APPLIANCES CORP., TAIPEI COUNTY (TW)

(21) Appl. No.: 12/871,128

(22) Filed: Aug. 30, 2010

(30) Foreign Application Priority Data
Sep. 4, 2009 (CN) 200910057876.9

(51) Int. Cl. G06F 15/173

(52) U.S. Cl. 709/224

(57) ABSTRACT

A network connection status detecting system is provided for detecting a network connection status of a server, and the detecting system includes a plurality of monitoring servers and a central processing server. Each monitoring server is communicably coupled to the server and continues detecting the network connection status of the server. If the detected network connection status of the server is offline, offline information including an offline starting time will be produced. The central processing server contains a selected time interval and receives the offline information to compute a time difference between the offline starting times. If all time differences are smaller than the selected time interval, then the central processing server determines that the network connection status of the server is an offline status and records the earliest offline starting time as an offline time.

### BACKGROUND OF THE INVENTION

1. Field of the Invention

The present invention relates to a detecting system and a method thereof, and more particularly to a detecting system and a method thereof for detecting a network connection of a server.

2. Description of the Related Art

In recent years, various devices are integrated in major systems such as air-conditioning systems, door security systems, network systems, and electric power systems, etc. Related devices such as network equipments and servers are installed and distributed all over the places. To understand the operating status of these devices, various monitoring software are introduced to generate real-time report information of the status of each device to inform the monitoring staffs if the operation of a factory is normal or not.

However, most monitoring software can monitor devices of a single type only. For example, an air-conditioning system monitoring software or a network management software is used for a respective purpose only, but the software cannot monitor all servers and network equipments, and such software can provide data and report within a particular monitoring range only.

In other words, a company requires several monitoring software to monitor various different equipments, and the company cannot centralize the monitor or systematically integrate the monitoring data analysis and the central database. In some cases, the plurality of monitoring software may have conflicts with each other, and the server may break down due to the conflicts.

Therefore, it is a primary objective of the present invention to provide a system and method for detecting a network connection status to overcome the aforementioned problems.

### SUMMARY OF THE INVENTION

The present invention relates to a network connection status detecting system and a method thereof, which comprises the steps of: using a plurality of monitoring servers to detect a network connection status of a server; computing an offline time of the server; providing users an accurate offline warning signal timely; and allowing users to control a server status by a systematic data access.

The detecting system of the present invention comprises a plurality of monitoring servers and a central processing server. Each monitoring server is communicably coupled to the server, and each monitoring server continues detecting a network connection status of the server. If the network connection status of the server is normal, then each monitoring server will be able to detect the server. If the server is shut down or its network cable is unplugged, then the network connection status is abnormal, and all monitoring servers will be unable to detect the server.

The monitoring server comprises a detecting unit, a timer and a processor. The detecting unit is coupled to the server for detecting a network connection status of the server. The timer is coupled to the detecting unit, such that if the detecting unit detects the network connection status of the server being offline, the timer will immediately record the time of the occurrence of the offline as an offline starting time. The processor is coupled to the detecting unit and the timer for receiving the network connection status and the offline starting time of the server. If the network connection status of the server is offline, the processor will immediately generate offline information, and the offline information includes information such as an offline starting time, an offline ending time, and an IP address of the server or a media access control (MAC) of the monitoring server.

The central processing server pre-installs a selected time interval and is coupled to each monitoring server for receiving the offline information. The central processing server comprises a computing unit and a database, and the computing unit is provided for computing a time difference between the offline starting times and comparing each computed time difference with the selected time interval. If each time difference is smaller than the selected time interval, then the network connection status of the server will be determined as an offline status, and the earliest one among these offline starting time is recorded as an offline time, and the database is provided for storing the offline information and the offline time.

If the central processing server determines that the network connection status of the server is an offline status, then the central processing server will generate an offline warning signal and transmit the offline warning signal to a remote device. For example, the offline warning signal is transmitted to the remote device such as a mobile phone of a monitoring staff or a server at a security counter via a short message or an email, and the offline warning signal includes the offline information and the offline time. The monitoring staff can know about the occurrence of the network disconnection of the server by the offline warning signal or by viewing the information stored in the database.

With the network connection status detecting system and the method thereof provided for detecting a server in accordance with the present invention, the monitoring staff can control the offline time precisely. After each monitoring server detecting a network disconnection of the server, it is necessary to compare each offline starting time with the selected time interval. If the difference is greater than the selected time interval, then there may an unstable communication connection between the server and certain sets of monitoring servers only and the server is not really offline. Therefore, the time interval between offline occurrence times can be reduced to obtain a more accurate offline occurrence time.

The central processing server provides users a systematic way of collecting and organizing data and reports an offline to the central processing server, regardless of which server is offline, so that users can know about the status of each device at a glance, and the present invention is user-friendly and efficient.

The advantages and spirit of the present invention will become apparent with the detailed description of preferred embodiments and the illustration of related drawings as follows.

### BRIEF DESCRIPTION OF THE DRAWINGS

FIG. 1 is a schematic view of a network connection status detecting system for detecting a server in accordance with the present invention;

FIG. 2 is a schematic view of a detailed structure of a detecting system in accordance with the present invention;

FIG. 3 is a schematic view of a detecting system with a small number of offline monitoring servers in accordance with the present invention; and

FIGS. 4A and 4B show a flow chart of a detecting method applied to a detecting system in accordance with the present invention.

### DETAILED DESCRIPTION OF THE PREFERRED EMBODIMENTS

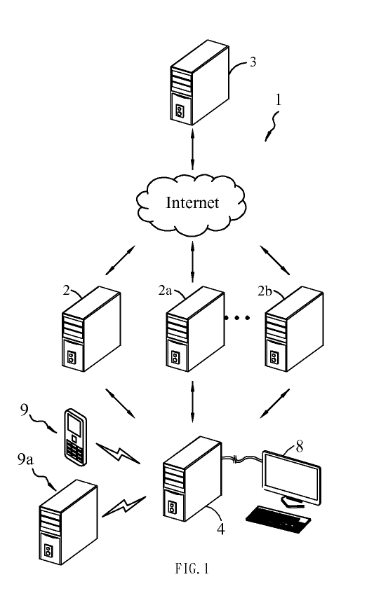

With reference to FIG. 1 for a schematic view of a network connection status detecting system for detecting a server in accordance with the present invention, the detecting system 1 uses a plurality of monitoring servers 2, 2a and 2b to connect a server 3 through a network. The monitoring servers 2, 2a and 2b are coupled to a central processing server 4.

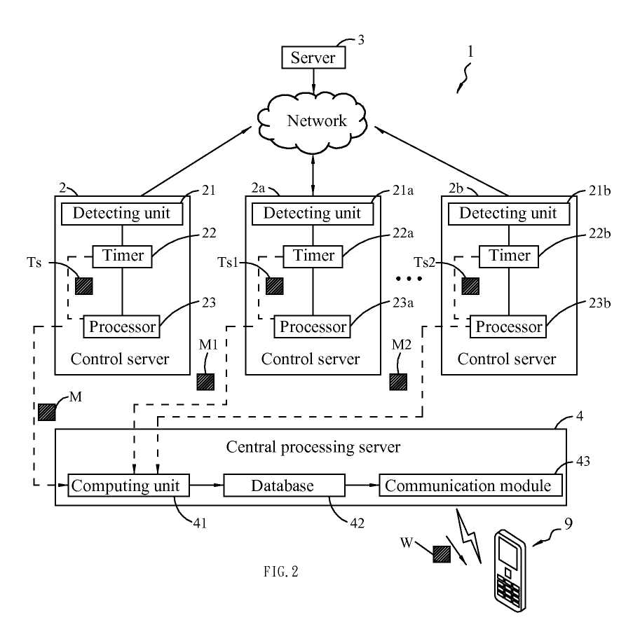

In this embodiment, three monitoring servers are taken as an example but not limited to. The monitoring servers 2, 2a and 2b are installed at different places respectively and communicably coupled to the server 3 via a cable or a wireless communication (not shown). The monitoring servers 2, 2a and 2b are provided for detecting a network connection status of the server 3. If the detected network connection status of the server 3 is offline, then offline information M (shown in FIG. 2) will be transmitted to the central processing server 4, and the central processing server 4 will receive each offline information M, M1 and M2 from each monitoring server 2, 2a and 2b and compare an offline starting time T_{S} contained in each offline information M, M1 and M2 with a selected time interval to determine whether the current network connection status of the server 3 is offline or online. If the server 3 is offline, then an offline warning signal W (shown in FIG. 2) will be transmitted to a monitoring staff and inform the monitoring staff that the server 3 cannot provide services at that moment.

The central processing server 4 can be coupled to a display screen 8, thus users can read the detecting result through the display screen 8 and know about the time recorded by the monitoring servers 2, 2a and 2b installed at different locations. In addition, the central processing server 4 can record information such as the number of interrupts and the usability performance according to the offline information M.

With reference to FIG. 2 for a schematic view of a detailed structure of a detecting system in accordance with the present invention, each monitoring server 2, 2a and 2b includes an address coding scheme such as the Internet Protocol Address (IP Address) or Media Access Control (MAC) for setting the monitoring server 2. Each monitoring server 2, 2a and 2b further comprises a detecting unit 21, 21a and 21b, a timer 22, 22a and 22b and a processor 23, 23a and 23b. The detecting unit 21, 21a and 21b continue detecting the network connection status of the server 3. It is assumed that the monitoring server 2 detects the network connection status of the server 3 being offline for illustrating. Once the server 3 cannot be detected, indicating that the network connection status of the server is offline, then the timer 22 will immediately record the time of the occurrence of the network disconnection as an offline starting time T_{S}. The processor 23 is coupled to the detecting unit 21 and the timer 22, such that if the server 3 is offline, the processor 23 will generate the offline information M. In the embodiment, the offline information M contains an offline starting time T_{S} recorded by the timer 22 and the address coding scheme of the monitoring server 2.

The central processing server 4 comprises a computing unit 41 and a database 42, and further comprises a communication module 43. The monitoring server 2 produces the offline information M to be transmitted to the computing unit 41. The computing unit 41 compares the offline starting time T_{S} detected by each monitoring server 2, and computes a time difference D between the offline starting times T_{S} to determine whether or not the time difference D is smaller than the selected time interval. If each time difference D is smaller than the selected time interval, then the central processing server 4 will determine the network connection status of the server 3 as an offline status at that moment, and each offline information M is stored in the database 42, and the earliest one of the stored offline starting times T_{S} is considered as the offline time. In addition, the communication module 43 is used for transmitting the offline warning signal W to a remote device such as a mobile phone 9 or a server 9a at a security counter to inform a monitoring staff. If any one of the time differences D is not smaller than the selected time interval, then the central processing server 4 will determine that the server is online, and each offline information M can be recorded or not recorded according to the user's setting.

With reference to FIG. 2, the server 3 is disconnected from the network, and any monitoring servers 2, 2a, 2b, etc. communicably coupled to the server 3 will be able to detect the network disconnection and generate offline information M, M1, M2, etc., so that the computing unit 41 will receive a plurality of offline information M, M1, M2, etc., and the computing unit 41 will compare each offline starting time T_{S}, T_{S1}, T_{S2}, etc. contained in each offline information M, M1, M2, etc. to calculate a time difference Dn between the offline starting times T_{S}. If |T_{S}−T_{S1}|=D1, |T_{S}−T_{S2}|=D2, |T_{S1}−T_{S2}|=D3, then D1, D2, D3 are compared with the selected time interval. If D1, D2, D3 are smaller than the selected time interval, then the earliest one of the offline starting times T_{S}, T_{S1}, T_{S2}, etc. (assumed that the offline starting time T_{S1} is the earliest detected offline time) is recorded as the offline time T_{S1} and stored in the database 42. T_{S1} is combined with the offline warning signal W to be transmitted to the remote device 9.

Assumed that a user sets the selected time interval to 3 minutes, each monitoring server 2 keeps detecting the occurrence of a network disconnection of the server 3 within three minutes, provided that every time difference D is smaller than 3 minutes. In other words, the time of the occurrence of a network disconnection of the server 3 falls within the three minutes for sure. Users can adjust the selected time interval as needed for adjusting the precision of detecting the network disconnection of the server.

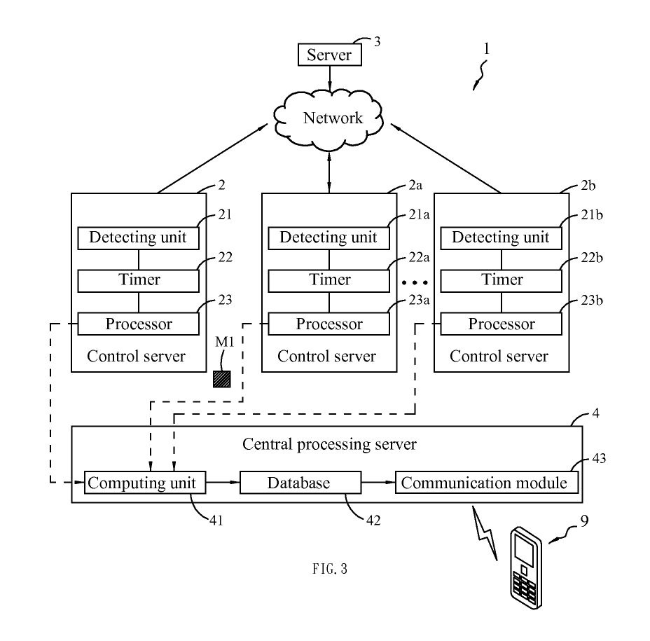

With reference to FIG. 3 for a schematic view of a detecting system with a small number of offline monitoring servers in accordance with the present invention, if the monitoring server 2a is disconnected with the network of the server 3, offline information M1 will also be produced. If a small number of monitoring servers 2 produce the offline information M, the central processing server 4 will be unable to compare all offline starting times T_{S}, so that the offline information M will not be recorded, so as to prevent any misjudgment made by the central processing server 4. Alternatively, the computing unit 41 can be set to compare the offline information M, if a specific quantity of offline information M is received.

Further, an offline ending time T_{E} is recorded, if the monitoring server 2 detects the time when the server resumes its online status from an offline status, and the time from the offline starting time T_{S} to the offline ending time T_{E} is defined as an interrupt period. Similarly, the interrupt period can be compared with the selected time interval. If each interrupt period is smaller than the selected time interval, it indicates a normal detected status of each monitoring server 2. If the interrupt period is not smaller than the selected time interval, it indicates that a certain monitoring server may be broken down. The foregoing determination mechanism can confirm detecting results made by the detecting system 1.

For example, if the selected time interval is set to 3 minutes, and the interrupt starting time T_{S} of the monitoring server 2 is 08:22, and the interrupt ending time T_{E} is 08:23, the interrupt period is 1 minute; if the interrupt starting time T_{S} of the monitoring server 2a is 08:21, and the interrupt ending time T_{E} is 09:53, the interrupt period is 1 hour and 32 minutes; and if the interrupt starting time T_{S} of the monitoring server 2b is 08:22, and the interrupt ending time T_{E} is 08:25, the interrupt period is 3 minutes. The time differences D are 1 minute, 0 minute, and 1 minute, which are smaller than the selected time interval (3 minutes), so that the central processing server 3 will determine that the network connection status of the server 3 is an offline status. If the interrupt period of the monitoring server 2a is much greater than the selected time interval, it indicates that the monitoring server 2a may be abnormal, so that users can know the exact location of the offline monitoring server 2a through the address coding scheme contained in the offline information M in order to repair the monitoring server 2a.

The monitoring server 2 can be a standalone computer or installed in the server 3. In other words, the detecting system 1 of the present invention may have a plurality of servers 3 for detecting and monitoring each other. For example, a server A can be used for monitoring an air-conditioning system, as well as serving as a monitoring server for another server B; and the server B can be used for monitoring a door security system as well as serving as a monitoring server of the server A.

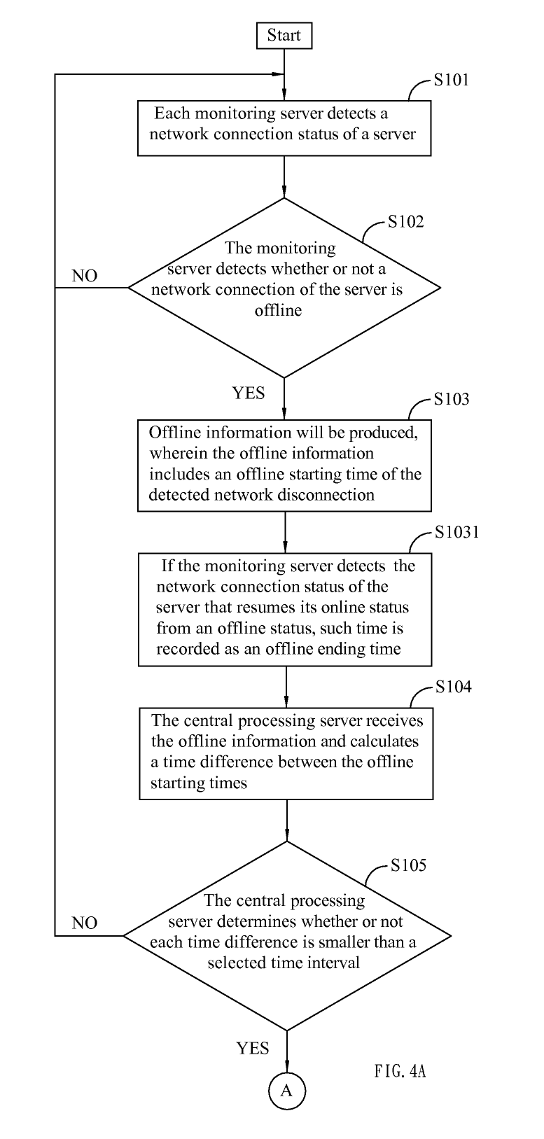

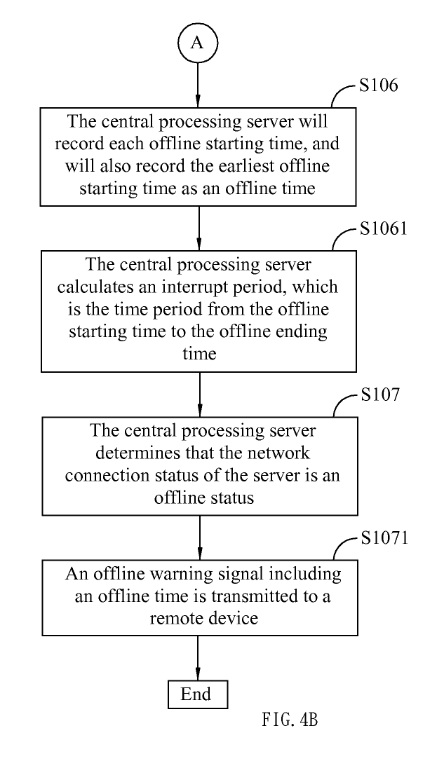

With reference to FIGS. 4A and 4B for a flow chart of a detecting method applied to the present invention, a clearer description of the detecting system is given, and the procedure of the detecting method comprises the following steps.

Step (S101): Each monitoring server detects a network connection status of a server.

Step (S102): The monitoring server detects whether or not a network connection of the server is offline, and the procedure returns to Step (S101) if the server is offline.

Step (S103): if the monitoring server detects an offline status in Step (S102), offline information will be produced, wherein the offline information includes an offline starting time of the detected network disconnection.

Step (S104): The central processing server receives the offline information and calculates a time difference between the offline starting times.

Step (S105): The central processing server determines whether or not each time difference is smaller than a selected time interval, and if the determination is negative, then the procedure returns to Step (S101).

Step (S106): if the determination is affirmative in Step (S105), then the central processing server will record each offline starting time, and will also record the earliest offline starting time as an offline time.

Step (S107): The central processing server determines that the network connection status of the server is an offline status.

Step S103 further comprises a step (S1031): If the monitoring server detects the network connection status of the server that resumes its online status from an offline status, such time is recorded as an offline ending time.

Step (S106) further comprises a step (S1061): The central processing server calculates an interrupt period, which is the time period from the offline starting time to the offline ending time.

The following Step (S1071) takes place, after Step S107 ends.

Step (S1071): An offline warning signal including an offline time is transmitted to a remote device.

With the network connection status detecting system and the method thereof in accordance with the present invention, the network connection status of the server is provided for users to detect the server, and the time difference is compared with the selected time interval to control the actual offline time of the server more precisely, and prevent a misjudgment of the monitoring server. In addition, users can know whether or not the status of each monitoring server is good, and the network connection statuses of the servers can be monitored by each other, so as to achieve the effects of maximizing the utility and saving the cost of purchasing additional monitoring servers.

What is claimed is:

1. A network connection status detecting system, for detecting a network connection status of a server, and the detecting system comprising:
a plurality of monitoring servers, separately connected to the server, for continuously detecting the network connection status of the server, such that if the network connection status of the server is disconnected, disconnection information of each disconnections is generated, wherein each disconnection information includes a starting time; and
a central processing server, having a predetermined selected time interval, and coupled to the monitoring servers for receiving the disconnection information to calculate a time difference value between the starting times of the disconnections;
wherein if the time difference value is smaller than the selected time interval, then the central processing server determines that the network connection status of the server is in a disconnected status, and the central processing server records the starting time of the disconnection, and records the earliest disconnection starting time as a disconnection time.

2. The detecting system of claim 1, wherein each of the monitoring servers comprises:
a detecting unit, coupled to the server, for detecting the network connection status of the server;
a timer, coupled to the detecting unit, such that if the detecting unit detects that the network connection status of the server is in the disconnected status, then the timer records the time of the occurred disconnection as the starting time of the disconnection; and
a processor, coupled to the detecting unit and the timer, for receiving the network connection status of the server and the disconnection starting time, such that if the network connection status of the server is in the disconnected status, then the processor generates the disconnection information.

3. The detecting system of claim 1, wherein the central processing server used for receiving the disconnection information comprises:
a computing unit, having the selected time interval, for calculating an interval between starting time of the disconnections to obtain the time difference values, and comparing the time difference values with the selected time interval; and
a database, for storing the disconnection information and the disconnection time;
wherein, if the time difference values are all smaller than the selected time interval, then the computing unit determines that the network connection status of the server is in the disconnected status, and the database is instructed to store the disconnection information and the disconnection time in accordance with the disconnected status.

4. The detecting system of claim 1, wherein the central processing server generates a disconnection warning signal if the central processing server determines that the network connection status of the server is in the disconnected status, and transmits the disconnection warning signal to a remote device, and the disconnection warning signal includes the disconnection information and the disconnection time.

5. The detecting system of claim 3, wherein the disconnection information includes a disconnection ending time, such that if the detecting unit detects that the network connection status of the server is in the connected status recovered from the disconnection, then the timer records the disconnection ending time.

6. A network connection status detecting method, suited for a detecting system comprising a plurality of monitoring servers being connected for communications through a server and a central processing server, and the method comprising the steps of:
(a) detecting a network connection status of the sever by the monitoring servers;
(b) detecting whether or not the network connection status of the server is in a disconnected status by the monitoring servers, and returning to Step (a) if the network connection status is in the disconnected status;
(c) generating disconnection information if the monitoring servers detect a disconnection in Step (b), wherein the disconnection information includes a disconnection starting time of the disconnection;
(d) receiving the disconnection information by the central processing server, and calculating a time difference value between starting times of the disconnections;
(e) determining whether or not the time difference value is smaller than a selected time interval by the central processing server, and returning to Step (a) if the time difference value is not smaller than the selected time interval;
(f) recording the disconnection starting time by the central processing server, if Step (e) has determined that the time difference value is smaller than the selected time interval, and recording the earliest disconnection starting time as a disconnection time; and
(g) determining the network connection status of the server is in the disconnected status by the central processing server.

7. The network connection status detecting method of claim 6, wherein a disconnection ending time is recorded if the monitoring server has detected the network connection status of the server is changed from the disconnected status to a connected status in Step (c).

8. The network connection status detecting method of claim 6, wherein after Step (g), the network connection status detecting method further comprises the Step of:
(g1) transmitting a disconnection warning signal including the disconnection time to a remote device.

9. The network connection status detecting method of claim 7, wherein after Step (f), the network connection status detecting method further comprises the Step of:
(f1) calculating a disconnection time interval between the disconnection starting time and the disconnection ending time by the central processing servers.
